(19) United States
(12) Patent Application Publication
(10) Pub. No.: US 2012/0284974 A1
(43) Pub. Date: Nov. 15, 2012

(54) ENGAGING CLIP

(75) Inventors: Kouta YAMAMOTO, Nagoya-shi (JP); Masami NAKANE, Toyota-shi (JP)

(73) Assignee: TOYOTA BOSHOKU KABUSHIKI KAISHA, Aichi-ken (JP)

(21) Appl. No.: 13/469,448

(22) Filed: May 11, 2012

(30) Foreign Application Priority Data
May 12, 2011 (JP) 2011-107070

(51) Int. Cl. F16B 2/20

(52) U.S. Cl. 24/458

(57) ABSTRACT

An engaging clip is provided, which enables a part of a cover material to be hung and engaged in a hanging recess formed in a cushion pad. The engaging clip includes a chuck part, to which a hanging part attached to the cover material is engaged, and a hook part which is hooked and engaged to an engaging member provided in the hanging recess of the cushion pad. The hook part includes a guide piece and a hook piece. The engaging member is inserted between the guide piece and the hook piece while the both pieces are bent outward so as to widen a gap therebetween, so that the hook piece is hooked and engaged to the engaging member. An end portion of the hook piece at a base side is connected to a side part of the chuck part to be supported in a cantilever manner.

### BACKGROUND OF THE INVENTION

1. Field of the Invention

The present invention relates to an engaging clip. Specifically, the present invention relates to an engaging clip which enables a part of a cover material to be hung and engaged in a hanging recess formed in a cushion pad.

2. Description of the Related Art

Conventionally, there has been known a configuration in which a plurality of surface parts of a cover material is hung and engaged in a hanging recess formed in a cushion pad by using resin engaging clips so as to stretch the cover material while being in close contact with a surface of the cushion pad (refer to Japanese Utility Model Registration No. 3163446). The engaging clip is configured by a chuck part for inserting therein and engaging a hanging part which is attached on a backside of the cover material, and a hook part which is hooked and engaged to an engaging wire which is provided such that a part of the engaging wire is exposed to the hanging recess of the cushion pad. The hook part is configured by a guide piece and a hook piece which are arranged to face each other in a horizontal direction. The wire is pushed in between the guide piece and the hook piece, so that the guide piece is pushed and bent outward and a gap is thus widened between the guide piece and the hook piece. The wire is guided and pushed in up to a position at which the wire is hooked by the hook piece.

According to the technique disclosed in the above publication, an end portion of the guide piece at a base side is connected to a side part of the chuck part, so that the guide piece is easily bent outward when the wire is pushed in between the guide piece and the hook piece. However, since the hook piece is connected to a bottom face part of the chuck part, it is not bent easily. Therefore, when pushing the wire between the guide piece and the hook piece, insertion load is increased.

### SUMMARY OF THE INVENTION

The present invention has been made in view of the above circumstances, and an object of the present invention is to decrease insertion load for inserting and engaging an engaging clip for hanging a cover material, with an engaging member in a hanging recess.

According to an illustrative embodiment of the present invention, there is provided an engaging clip enabling a part of a cover material to be hung and engaged in a hanging recess formed in a cushion pad. The engaging clip comprises a chuck part, to which a hanging part attached to the cover material is engaged, and a hook part which is hooked and engaged to an engaging member provided in the hanging recess of the cushion pad, wherein the hook part includes a guide piece and a hook piece which are arranged to face each other, the engaging member is inserted between the guide piece and the hook piece while the guide piece and the hook piece are bent outward so as to widen a gap therebetween, and the hook piece is thus hooked and engaged to the engaging member inserted into the gap, and wherein an end portion of the hook piece at a base side is connected to a side part of the chuck part to be supported in a cantilever manner.

According to the above configuration, when the engaging member is inserted between the guide piece and the hook piece, both pieces of the hook part are respectively bent outward so that the gap between the pieces is widened. Thereby, the hook part enables the engaging member to be inserted up to a position at which the engaging member is hooked by the hook piece. And, the hook piece is connected to the side part of the chuck part and is thus supported in a cantilever manner. Therefore, it is possible to reduce the insertion load for inserting and engaging the hook part with the engaging member.

The above engaging clip may be configured such that an end portion of the guide piece at a base side is connected to one side part of the chuck part to be supported in a cantilever manner, the end portion of the hook piece at the base side is connected to another side part of the chuck part to be supported in a cantilever manner, and a bottom face part of the chuck part is formed with a guide surface which guides the engaging member inserted between the guide piece and the hook piece up to a position at which the engaging member can be hooked by the hook member.

According to the above configuration, the guide piece and the hook piece are respectively connected to the one or another side part of the chuck part and are thus supported in a cantilever manner, so that it is possible to enable the respective pieces to be easily bent outward. Also, the guide surface, which moves and guides the inserted engaging member up to the position at which the engaging member is hooked by the hook piece, is provided to the bottom face part of the chuck part, other than the guide piece or hook piece. Thereby, it is possible to appropriately guide the inserted engaging member up to the position at which the engaging member is hooked by the hook piece without disturbing the bending of the guide piece or hook piece.

The above engaging clip may be configured such that a connection position of the end portion of the guide piece at the base side, which is connected to the one side part of the chuck part, is more distant position than a connection position of the end portion of the hook piece at the base side, which is connected to the another side part of the chuck part, in an insertion direction of the engaging member.

According to the above configuration, the guide piece is made such that it is bent more easily than the hook piece. Thereby, it is possible to realize the configuration of appropriately reducing the insertion load when inserting the engaging member between the guide piece and the hook piece while appropriately securing the structural strength of the hook piece engaging the engaging member.

### BRIEF DESCRIPTION OF THE DRAWINGS

In the accompanying drawings:

FIG. 1 is a sectional view showing a hanging structure of a cover material according to a first illustrative embodiment;

FIG. 2 is a perspective view showing the structure of FIG. 1, which is seen from an oblique angle;

FIG. 3 is a perspective view of an engaging clip;

FIG. 4 shows a state before a hanging part is inserted into a chuck part;

FIG. 5 shows a state where the hanging part is inserted into the chuck part up to a limit position;

FIG. 6 shows a state where the hanging part is engaged to the chuck part;

FIG. 7 shows a state before a wire is inserted into a hook part;

FIG. 8 shows a state where the hook part is pushed and thus widened by the insertion of the wire;

FIG. 9 shows a state where the wire is inserted to a position coming into contact with a curved surface;

FIG. 10 shows a state where the wire is inserted into the hook part up to a limit position; and

FIG. 11 shows a state where the hook part is engaged to the wire.

### DETAILED DESCRIPTION

Hereinafter, illustrative embodiments of the present invention will be described with reference to the drawings.

### First Illustrative Embodiment

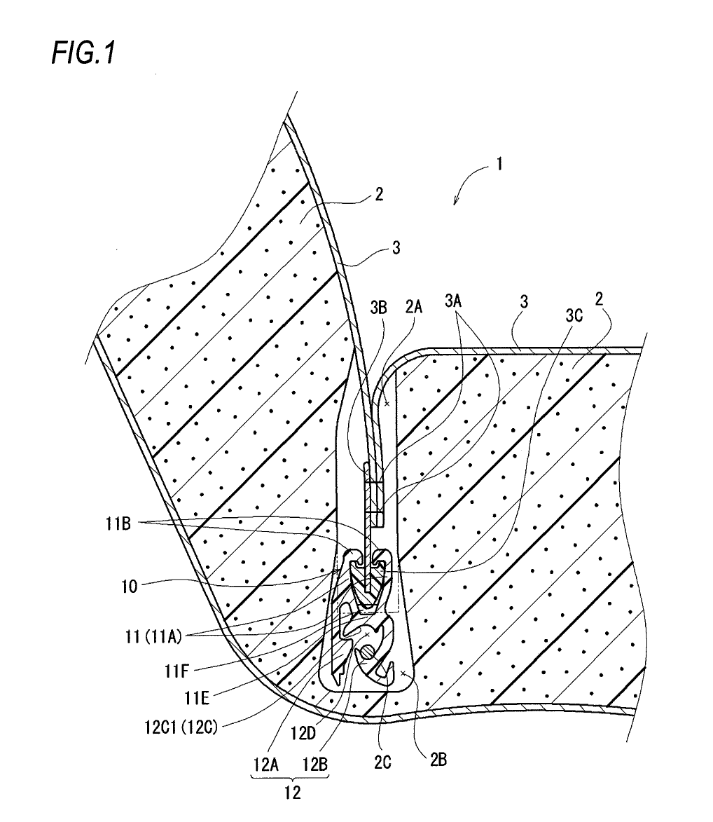

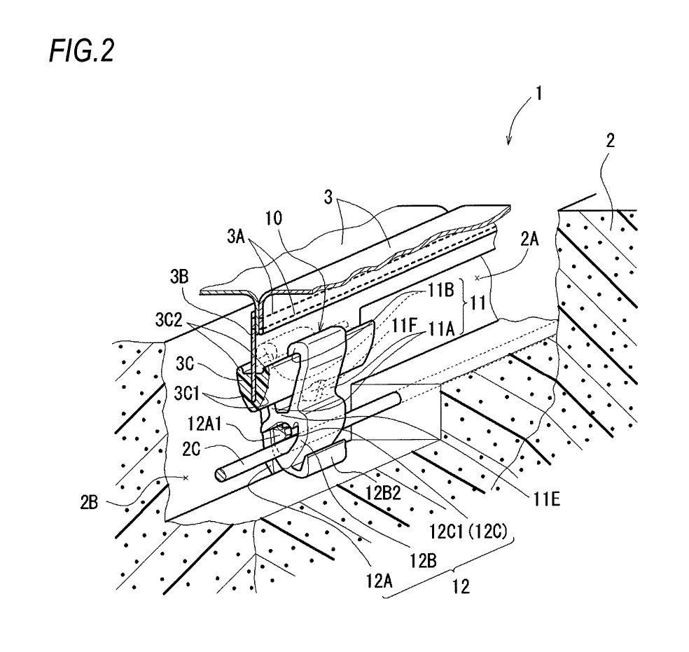

First, a configuration of an engaging clip 10 according to a first illustrative embodiment is described with reference to FIGS. 1 to 11. As shown in FIGS. 1 and 2, regarding a vehicle seat cushion 1, the engaging clip 10 of this illustrative embodiment is used to hang and engage a plurality of surface parts of a cover material 3 made of a fabric material in a hanging recess 2A formed in a cushion pad 2 made of a foamed material of urethane resin, so as to stretch the cover material 3 while being in close contact with a surface of the cushion pad 2. Specifically, in a region where the problems such as ‘floating’ and ‘wrinkle’ occur when stretching the cover material 3, for example, a boundary region between a central part which becomes a seating part of the seat cushion 1 and a side support part which is convexly formed at a side of the central part, the engaging clip 10 is applied to hang and engage a part of the cover material 3 in the hanging recess 2A of the cushion pad 2 formed along the region so as to prevent the problems, thereby enabling the cover material 3 to be stretched while being favorably in close contact with the surface of the cushion pad 2.

The engaging clip 10 is integrally formed by a synthetic resin material such as polypropylene, polyethylene and the like, and includes a chuck part 11 and a hook part 12. The chuck part 11 is engaged with a hanging part 3C by insertion which is attached on a backside of the cover material 3. The hook part 12 is hooked and engaged to an engaging wire 2C (an example of an engaging member) which is provided such that a part of the engaging wire is exposed to the hanging recess 2A of the cushion pad 2. Specifically, the chuck part 11 has a pair of holding pieces 11 A which surrounds and engages the hanging part 3C, which is inserted therein from the upper part in FIG. 1, from both sides such that the hanging part is not deviated.

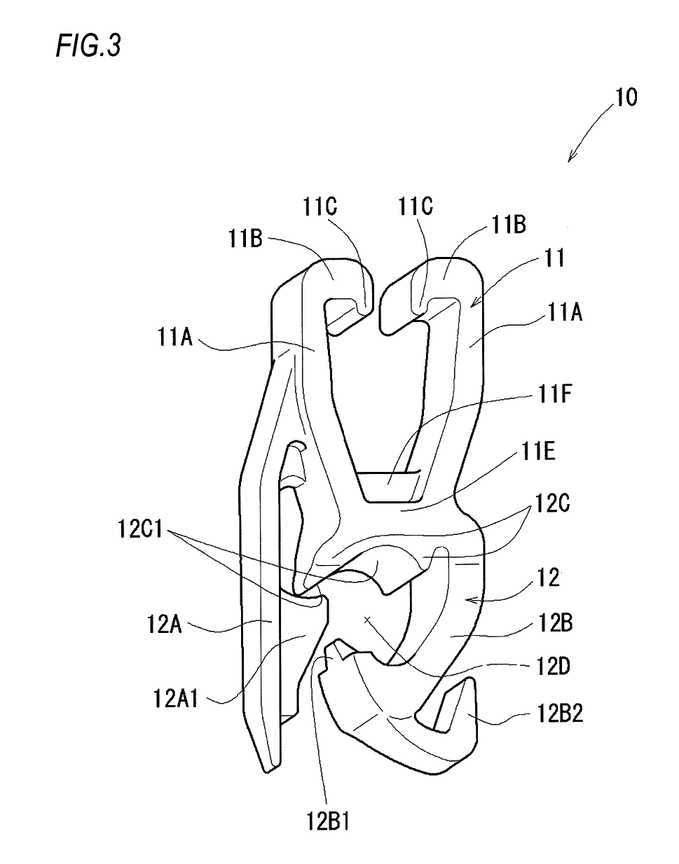

As shown in FIG. 3, the pair of holding pieces 11A extends obliquely outward from two positions spaced from each other on a bottom face part 11E toward the above side in FIG. 3 so that they are opened, and then extends straightly toward the upper side. Upper end portions of the holding pieces 11A are respectively formed with closing parts 11B which extend at right angles toward opposing sides (inner sides). The upper side of the closing parts 11B has a flat face, so that a pressing force can be effectively applied by a hand. Inner end portions of the respective closing parts 11B are respectively formed with protrusions 11C which protrude downward in FIG. 3. The closing parts 11B form a gap between opposing inner surfaces thereof and the hanging part 3C can be inserted between the closing parts through the gap from the upper side.

Here, as shown in FIGS. 1 and 2, the hanging part 3C is attached on a backside part of a region in which it is hung in the hanging recess 2A of the cover material 3, as described below. That is, regarding seamed parts 3A at which an edge part of a surface material covered on the central part of the cushion pad 2 of the cover material 3 and an edge part of a surface material covered on the side support part are opposed and seamed each other such that the edge parts protrude to the backside of the cover material 3, the hanging part 3C is integrally connected with a lower end edge part of a hanging fabric 3B which is seamed together with the seamed parts 3A. The hanging fabric 3B is continuously provided over a longitudinal wide area in which the seamed parts 3A are formed, and a plurality of the hanging parts 3C, each of which has an elongated shape is discretely provided at several positions of the hanging fabric 3B. A region of the hanging fabric 3B in which the hanging part 3C is not connected is partially cut to shorten a fabric length, so that the respective fabric regions in which the hanging parts 3C are provided are easily bent independently. Also, a plurality of the engaging clips 10 for hanging and engaging each hanging part 3C in the hanging recess 2A of the cushion pad 2 and a plurality of exposing parts (engaging recesses 2B) of the wire 2C for engaging the engaging clips 10 are discretely provided at the respective longitudinal positions corresponding to the setting positions of the hanging parts 3C, respectively.

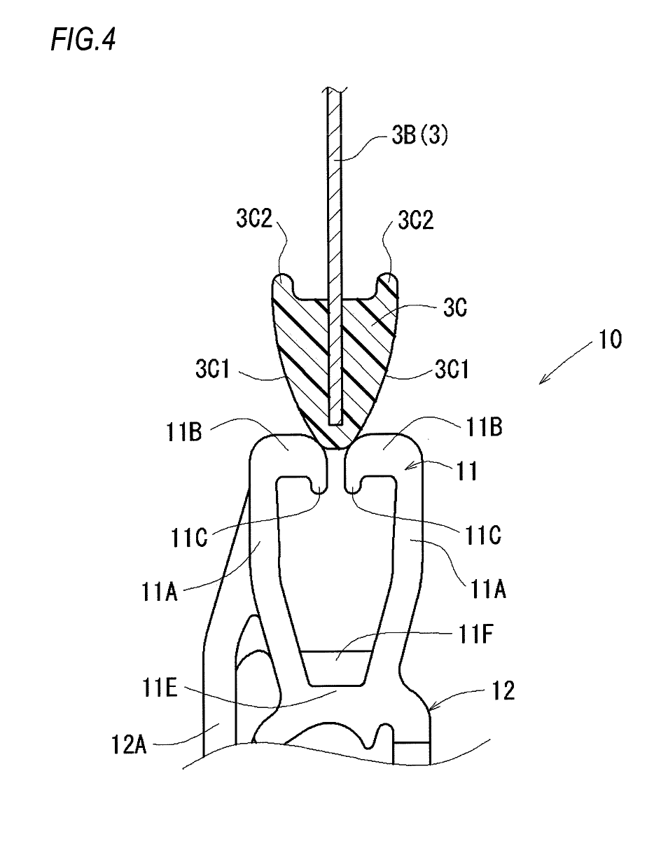

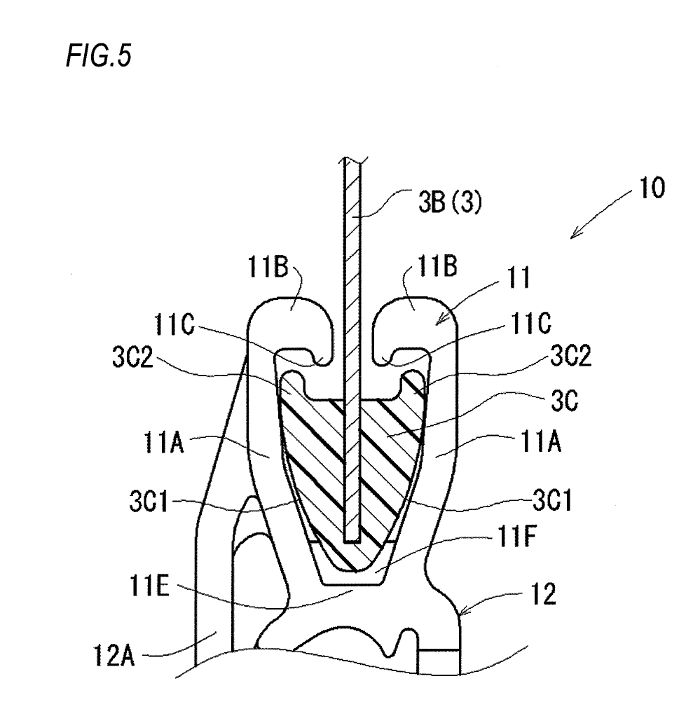

As shown in FIGS. 2 and 4, the hanging part 3C has a sectional shape of an inverted triangle which extends in a taper shape toward a lower end side thereof which is a leading end side of the insertion, and respective surfaces forming both side surfaces of the taper shape are formed as inclined surfaces 3C1 which are curved to be convex outward. Also, an upper side surface part of the hanging part 3C is formed at its both ends with protrusions 3C2 which protrude upward. The protrusions 3C2 are formed to have a protuberance shape continuously extending in the longitudinal direction of the hanging part 3C. As shown in FIGS. 4 to 6, the hanging part 3C is inserted and engaged to the chuck part 11 of the engaging clip 10, as described below. As shown in FIG. 4, when the hanging part 3C is pushed downward and inserted into the gap between the closing parts 11B of both holding pieces 11 A of the chuck part 11, the respective closing parts 11B are pushed and opened outward by the respective inclined surfaces 3C1 of the hanging part 3C. Thereby, as shown in FIG. 5, the respective holding pieces 11A are bending-deformed, so that they are pushed and opened outward about lower end portions serving as supporting points connected to the bottom face part 11E. As a result, the hanging part 3C is inserted into the gap between the holding pieces 11A. As shown in FIG. 5, the hanging part 3C is inserted such that the hanging part 3C is pulled out downward from the contact state with both closing parts 11B and then the leading end portion (lower end portion) of the hanging part 3C is pressed and supported on a stopper 11F having a standing plate shape and provided on the bottom face part 11E of the chuck 11. By the insertion, both holding pieces 11A released from the contact state with the hanging part 3C are restored, so that both closing parts 11B are moved in the direction (the inward direction) of closing the opening. Thereby, the hanging part 3C is held from both sides by the closed holding pieces 11A and is surrounded by the closing parts 11B so that they are not pulled out from the chuck part 11. Here, the stopper 11F is connected to the bottom face part 11E and base parts of both holding pieces 11A so that the stopper 11F connects the base parts.

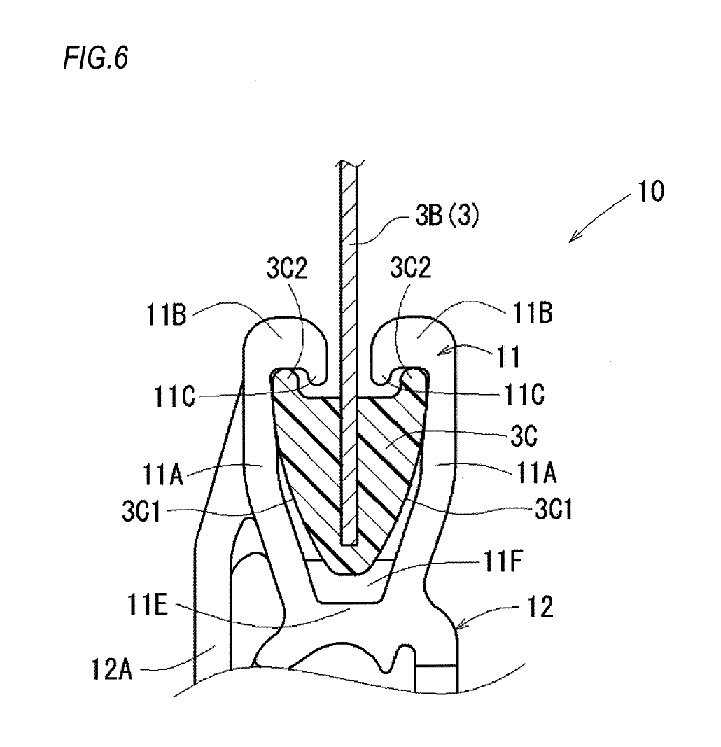

After the hanging part 3C is inserted, a hand is separated from the insertion operation. Thereby, as shown in FIG. 6, the hanging part 3C is returned in an opposite direction to the insertion direction by elastic force resulting from the restoration of the stopper 11F. Hence, the respective protrusions 3C2 of the hanging part 3C, which are formed on both end portions of the upper surface part of the hanging part, are pressed and engaged to the respective closing parts 11B and the respective protrusions 11C which are formed on the inner end portions of the respective closing parts 11B are positioned at the inner sides of the respective protrusions 3C2. Thereby, even when rightward, leftward or longitudinally oblique tensioning force is applied to the chuck part 11 due to tensile force applied to the cover material 3 at the time of using the hanging part 3C, the hanging part 3C is kept at a deviation prevented state by the strong force with which it is not pulled out from the chuck part 11 due to the engagement between the protrusions 3C2 and the protrusions 11C.

In the below, a configuration of the hook part 12 is described. As shown in

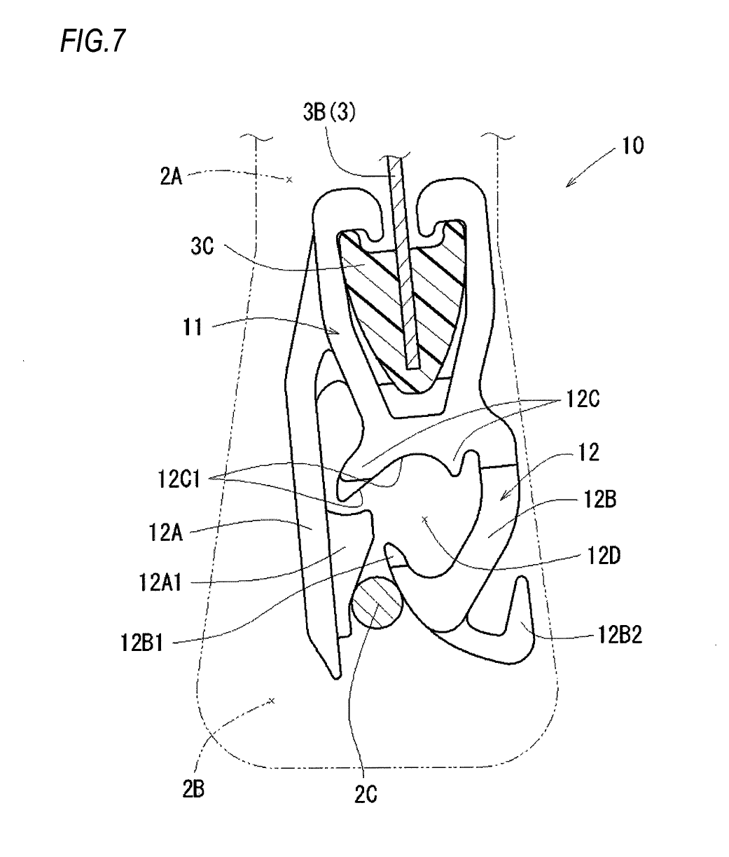

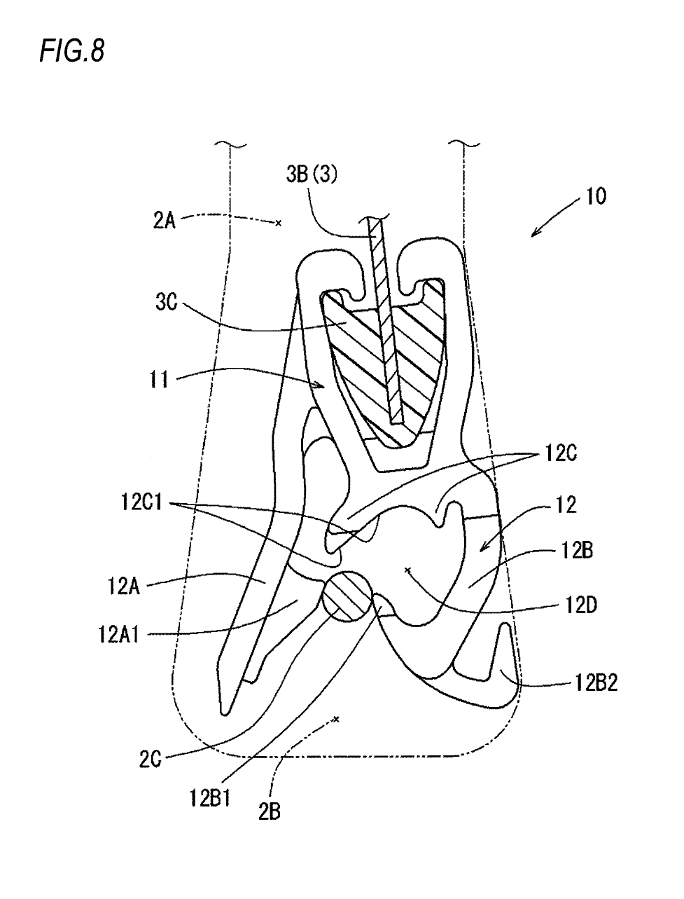

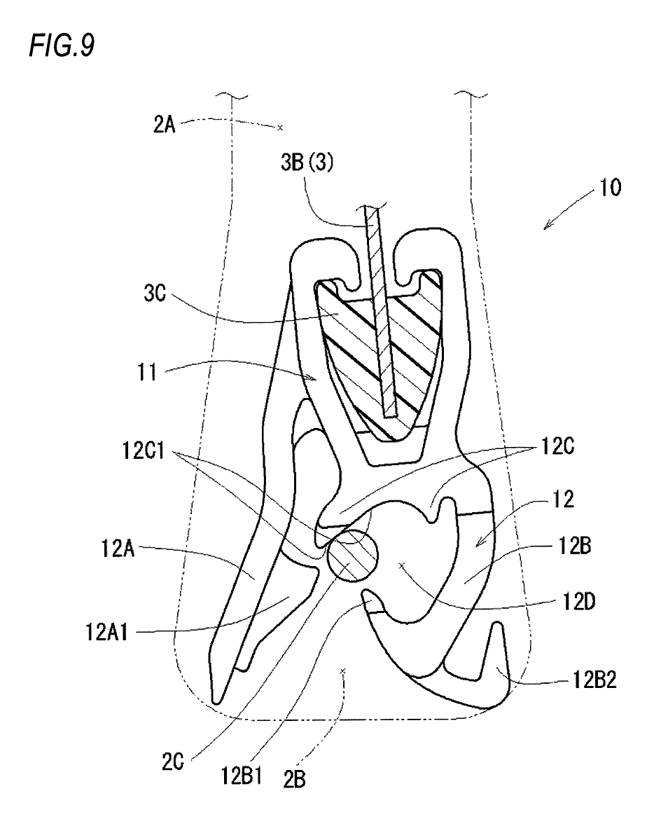

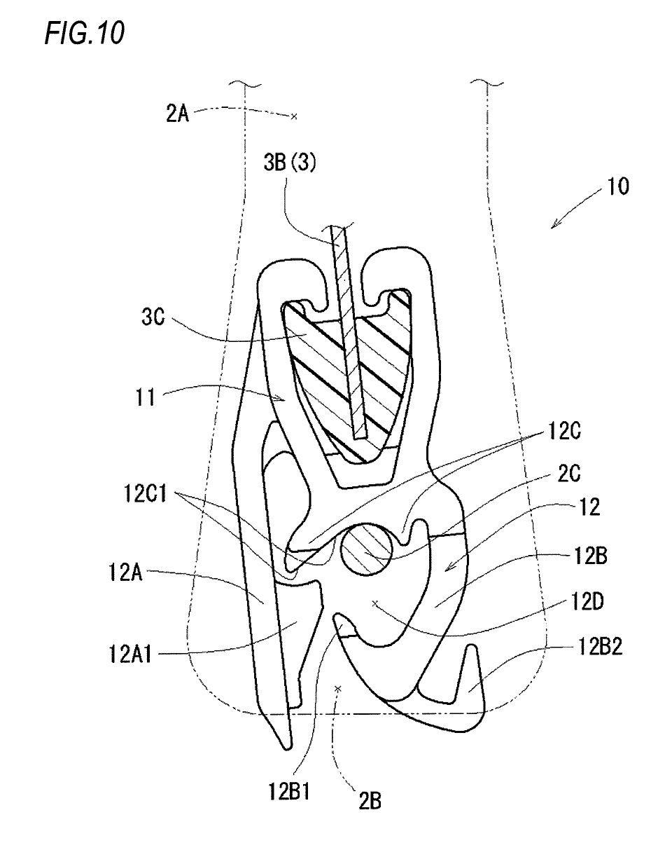

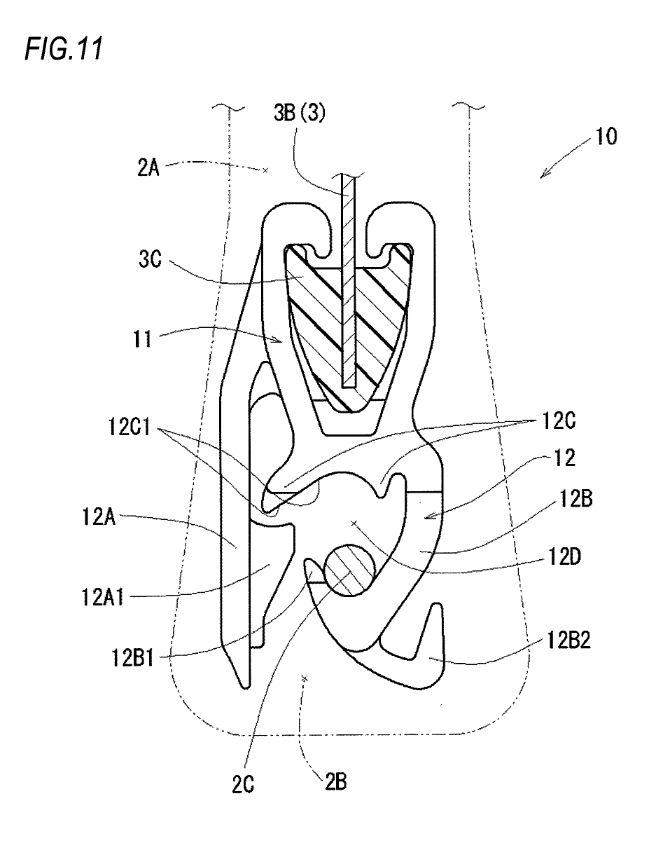

FIG. 3, the hook part 12 has a guide piece 12A and a hook piece 12B, which are arranged to face each other in a horizontal direction, a support piece 12C which is formed on a bottom face side of the bottom face part 11E of the chuck part 11. The guide piece 12A is formed to extend downward from an outer surface part in an upper side area straightly extending to the upper side of the one holding piece 11A of the chuck part 11. Also, the hook piece 12B is formed to extend from an outer surface part in a lower side area obliquely extending to the upper side of the other holding piece 11 A of the chuck part 11 and to extend obliquely outward and then extend downward so that it is bent in a hook shape at an inner side which faces the guide piece 12A. In other words, the hook piece 12B has a curved portion which protrudes outward in a direction opposite to the guide piece. The support piece 12C is formed such that it forms a concave curved surface 12C1 (an example of a guide surface) on the bottom face side of the bottom face part 11E of the chuck part 11. As shown in FIGS. 7 to 11, when the hook part 12 is pushed to the wire 2C which is exposed to the hanging recess 2A of the cushion pad 2, the hook part guides the wire 2C into a tapered gap which is formed by tip ends of the guide piece 12A and the hook piece 12B (refer to FIG. 7), and the guide piece 12A and the hook piece 12B are respectively bent outward to widen the gap therebetween (refer to FIG. 8), so that the wire 2C is inserted into a space 12D surrounded by the guide piece 12A, the hook piece 12B and the support piece 12C (refer to FIGS. 9 and 10). As a result, the wire 2C is hooked and engaged by the hook piece 12B so that it cannot be not pulled out (refer to FIG. 11).

Specifically, as shown in FIG. 3, the guide piece 12A is formed with a guide protrusion 12A1 on an inner surface part in the lower side area facing the hook piece 12B. The guide protrusion 12A1 is inclined upward such that a protruding amount thereof is increased as it is directed upward. Also, the hook piece 12B is formed with a tapered portion 12B1 on a center of a tip end part thereof bent into a hook shape. The tapered portion 12B1 steeply protrudes in a taper shape toward a tip end side. As shown in FIG. 7, at a free state, the tapered portion 12B1 comes close to the guide protrusion 12A1 of the guide piece 12A. Also, as shown in FIGS. 8 to 10, the support piece 12C guides and positions the wire 2C inserted into the gap between the tip end part of the guide piece 12A and the tip end part of the hook piece 12B, so that the wire is located just above the bent part of the hook piece 12B by the shape of the curved surface 12C1. The curved surface 12C1 is formed such that the deepest recess portion thereof is located just above the bent part of the hook piece 12B. Also, when the inserted wire 12C is brought into contact with the curved surface, the curved surface moves the wire 2C to the deepest recess portion, as shown in FIG. 10.

After the hanging part 3C attached on the backside of the cover material 3 is inserted and engaged to the chuck part 11 of the engaging clip 10, the hook part 12 is pushed to the wire 2C which is exposed to the hanging recess 2A of the cushion pad 2 and is thus engaged to the wire 2C. Here, as shown in FIG. 2, the wire 2C is inserted when foam-molding the cushion pad 2, so that it is embedded in the deeper part than the hanging recess 2A. Also, the wire 2C is provided such that a part thereof is exposed to the outside by the engaging recesses 2B which are formed to be deeper than the hanging recess 2A.

The hook part 12 having the above configuration is pushed to the wire 2C which is exposed to the engaging recess 2B, so that the wire 2C is inserted into the gap between the guide protrusion 12A1 of the guide piece 12A and the steeple portion 12B1 of the hook piece 12B, as shown in FIG. 7. Thereby, the guide piece 12A and the hook piece 12B are respectively bending-deformed by the pressing force of the wire 2C so that they are respectively pushed and opened outward about the connection end portions (which also serve as the supporting points) with the respective side face parts of the chuck part 11 which is the base parts of the guide piece 12A and the hook piece 12B (refer to FIG. 8). As a result, the wire 2C is received at the position at which it is brought into contact with the curved surface 12C1 of the support piece 12C through the gap between the guide piece and the hook piece (refer to FIG. 9). Thereby, the guide piece 12A and the hook piece 12B are released from the contact state with the wire 12C and are restored, so that the opening gap between the guide protrusion 12A1 and the steeple portion 12B1 of the wire 12C is closed. Specifically, when the wire 12C is inserted, the guide piece 12A and the hook piece 12B are bending-deformed. At this time, as described above, since the guide piece 12A is connected to the side part of the chuck part 11 at the higher position (the more distant position with respect to the insertion direction of the wire 2C) than the hook piece 12B and the length of the cantilevered piece is longer, the guide piece 12A is more bent outward than the hook piece 12B. Further, it is noted that an end portion of the guide piece 12A in an opposite direction to the insertion direction of the wire 2C has an inclined surface, and an end portion of the hook piece 12B in the opposite direction has an inclined surface. And, the inclined surface of the guide piece 12A is inclined in a same direction as the inclined surface of the hook piece 12B with respect to the insertion direction of the wire 2C. Therefore, the insertion load can be effectively reduced.

The insertion of the wire 12C into the hook part 12 can be made up to the position at which the wire 2C, which is brought into contact with the curved surface 12C1 of the support piece 12C by the pressing force of the hook part 12, is moved to the deepest recess portion of the curved surface 12C1 by the guide of the shape of the curved surface 12C1, as shown in FIG. 10. By this insertion, the wire 12C is located just above the bent part of the hook piece 12B. Therefore, when the hand is separated from the inserting operation of the hook part 12, the engaging clip 10 is pulled in an opposite direction to the insertion direction by the tensile force applied to the cover material 3, so that the wire 2C is hooked and engaged to the hook piece 12B, as shown in FIG. 11. Thereby, a part of the cover material 3 is hung and engaged in the hanging recess 2A of the cushion pad 2.

Here, a jig hooking portion 12B2 which is bent in an opposite direction to the bent direction of the hook piece 12B is formed at an outer side part of the bent lower end portion of the hook piece 12B. When disengaging the wire 12C engaged to the hook part 12 from the engaged state with the hook piece 12, the jig hooking portion 12B2 receives a jig such as screw driver by a bent recess shape thereof and then the hook piece 12B is forcibly bending-deformed outward by the jig, so that the gap between the guide piece 12A and the hook piece is widened and the wire 12C can be thus deviated.

As described above, according to the engaging clip 10 of this illustrative embodiment, the hook piece 12B of the hook part 12 is connected to the side part of the chuck part 11 at the end portion of the base side thereof and is thus supported in a cantilever manner. Hence, when inserting the wire 2C, the hook piece is easily bent outward together with the guide piece 12A such that the gap between the hook piece and the guide piece is widened. Thereby, it is possible to reduce the insertion load with which the wire 2C is inserted and engaged into the hook part 12. Also, the guide surface (curved surface 12C1) which moves and guides the inserted wire 2C up to the position at which the wire can be hooked by the hook piece 12B is provided to the bottom face part 11E of the chuck part 11, other than the guide piece 12A or hook piece 12B. Thereby, it is possible to appropriately guide the inserted wire 2C up to the position at which the wire is hooked by the hook piece 12B without disturbing the bending of the guide piece 12A or hook piece 12B. Also, the connection position of the end portion of the base side of the guide piece 12A with the side part of the chuck part 11 is set at the more distant position than the connection position of the end portion of the base side of the hook piece 12A, with respect to the insertion direction of the wire 2C. Thereby, the guide piece 12A is made such that it is bent more easily than the hook piece 12B. As a result, it is possible to realize the configuration of appropriately reducing the insertion load when inserting the wire 2C between the guide piece 12A and the hook piece 12B while appropriately securing the structural strength of the hook piece 12B engaging the wire 2C.

Although one illustrative embodiment of the present invention has been described, the present invention can be variously implemented in addition to the above illustrative embodiment. For example, the engaging clip can be used to hang and engage a part of a cover material in a hanging recess formed in a cushion pad in the other seat structure part such as seat back, in addition to the vehicle seat cushion. Also, the engaging clip can be applied to a variety of the same configurations other than the vehicle seat (for example, a configuration of hanging and engaging a part of a cover material in a hanging recess formed in a cushion pad). Also, the guide surface (curved surface 12C1 in the above illustrative embodiment) may not be curved and may be a straight inclined surface or step-wise surface. Also, the guide surface may be formed on the guide piece or hook piece, other than the bottom face part of the chuck part. In this case, however, the guide surface is preferably formed such that it does not continue to the bottom face part of the chuck part. When the guide surface is formed to continue to the guide piece or hook piece and the bottom face part of the chuck part, the bending of the guide piece or hook piece could be interfered.

What is claimed is:

1. An engaging clip enabling a part of a cover material to be hung and engaged in a hanging recess formed in a cushion pad, the engaging clip comprising:
a chuck part, to which a hanging part attached to the cover material is engaged; and
a hook part which is hooked and engaged to an engaging member provided in the hanging recess of the cushion pad,
wherein the hook part includes a guide piece and a hook piece which are arranged to face each other, the engaging member is inserted between the guide piece and the hook piece while the guide piece and the hook piece are bent outward so as to widen a gap therebetween, and the hook piece is thus hooked and engaged to the engaging member inserted into the gap, and
wherein an end portion of the hook piece at a base side is connected to a side part of the chuck part to be supported in a cantilever manner.

2. The engaging clip according to claim 1,
wherein the end portion of the hook piece at the base side is connected to the side part of the chuck part to be supported in a cantilever manner, so that the hook piece is apt to be bent to widen the gap between the guide piece and the hook piece when inserting the engaging member.

3. The engaging clip according to claim 1,
wherein an end portion of the guide piece at a base side is connected to one side part of the chuck part to be supported in a cantilever manner, the end portion of the hook piece at the base side is connected to another side part of the chuck part to be supported in a cantilever manner, and a bottom face part of the chuck part is formed with a guide surface which guides the engaging member inserted between the guide piece and the hook piece up to a position at which the engaging member can be hooked by the hook member.

4. The engaging clip according to claim 3,
wherein a connection position of the end portion of the guide piece at the base side, which is connected to the one side part of the chuck part, is more distant position than a connection position of the end portion of the hook piece at the base side, which is connected to the another side part of the chuck part, in an insertion direction of the engaging member.

5. The engaging clip according to claim 1,
wherein the hook piece has a curved portion which protrude in a direction opposite to the guide piece.

6. The engaging clip according to claim 1,
wherein an end portion of the guide piece in an opposite direction to the insertion direction of the engaging member has an inclined surface,
wherein an end portion of the hook piece in the opposite direction has an inclined surface, and
wherein the inclined surface of the guide piece is inclined in a same direction as the inclined surface of the hook piece with respect to the insertion direction of the engaging member.

7. The engaging clip according to claim 1,
wherein an end portion of the hook piece in an opposite direction to the insertion direction of the engaging member has a jig hooking portion which is bent in a direction opposite to the guide piece.

8. The engaging clip according to claim 1,
wherein the chuck part has a flat face at an end portion in the insertion direction of the engaging member.
